(19) United States
(12) Patent Application Publication
(10) Pub. No.: US 2012/0256950 A1
(43) Pub. Date: Oct. 11, 2012

(54) MEDICAL SUPPORT APPARATUS, MEDICAL SUPPORT METHOD, AND MEDICAL SUPPORT SYSTEM

(75) Inventors: Kenji Masuda, Osaka (JP); Yuki Horii, Kyoto (JP)

(73) Assignee: PANASONIC CORPORATION, Osaka (JP)

(21) Appl. No.: 13/515,030

(22) PCT Filed: Dec. 5, 2011
(86) PCT No.: PCT/JP2011/006802

§ 371 Date: Jun. 11, 2012

(30) Foreign Application Priority Data
Dec. 17, 2010 (JP) 2010-281586

(51) Int. Cl. G09G 5/00

(52) U.S. Cl. 345/629

(57) ABSTRACT

A medical support apparatus includes: an image capturing unit obtaining an image capturing signal; an attitude observing unit obtaining an attitude of the image capturing unit; a position observing unit obtaining a position of the image capturing unit; an operation detecting unit detecting an operation of the user and an operation position; a superimposed information constructing unit generating superimposed information including superimposed details and information on the operation position, according to a type of the operation; a display management unit generating an image to be displayed, based on the position and the attitude; a display unit displaying a screen on which the image generated by the display management unit is superimposed on a viewpoint image of the image capturing unit; and a communication unit transmitting the superimposed information to at least one other medical support apparatus.

### TECHNICAL FIELD

The present invention relates to a medical support system that provides medical support by sharing, among users including a doctor in a remote area, a view or an operation of at least one of the users.

### BACKGROUND ART

In recent years, public concern regarding problems facing an aging society has grown. The aging is progressing particularly in rural areas, and it is estimated that the aging will be accelerated in underpopulated areas rather than urban areas. Furthermore, medical agencies equipped with advanced medical facilities tend to concentrate in the urban areas. People in the underpopulated areas are forced to depend on the medical agencies in the urban areas so as to take sufficient medical treatment at present. The situation physically, economically, and temporally burdens not only the patients but also the families to a larger extent in the underpopulated areas. Here, the remote medical care using communication devices receive a great deal of attention. The remote medical care generally uses video conferencing equipment. The video conferencing equipment includes peripheral devices connected to respective computers. Using the equipment, a doctor obtains medical data of a home-care patient in a remote area in real time, and examines the patient with conversation through bidirectional communication using images and voices. For example, PTL 1 is known as describing such a conventional technique. PTL 1 provides a home care medical support system in which a doctor obtains medical data of a home-care patient in a remote area in real time, and examines the patient with conversation through bidirectional communication using images and voices. This system is useful in remote diagnosis. The conventional technique is applicable to medial treatment. It is expected that the system will be applied to, in particular, sharing information of patients under the authority in remote areas and advising operations.

### CITATION LIST

### Patent Literature

[PTL 1] Japanese Unexamined Patent Application Publication No. 8-215158

### SUMMARY OF INVENTION

### Technical Problem

In the conventional video conferencing system, the position of a display device is fixed, and the screen has a flat surface with a finite size. When participants of a conference confirm respective screens of the display devices, their eye directions are to be fixed. Furthermore, when a knowledgeable person who participates in the video conference from a remote area advises a participant who is giving medical treatment on site on the basis of images, the participant has to avert his/her eyes from the affected area while the participant is alternately listening to the advices involving checking of the screen and giving the medical treatment. When it is necessary to perform smooth operations, the video conferencing system interferes with the treatment, and causes a trouble.

The present invention has been conceived to solve the conventional problems, and has an object of providing a medical support system that provides medical support by sharing, among users including a doctor in a remote area, a view or an operation of at least one of the users.

### Solution to Problem

In order to solve the conventional problems, a medical support apparatus according to the present invention is a medical support apparatus for sharing, among users, a view or an operation of at least one of the users, and includes: an image capturing unit configured to capture an image according to the view of the user to obtain an image capturing signal; an attitude observing unit configured to obtain information on an attitude of the image capturing unit; a position observing unit configured to obtain information on an image capturing position of the image capturing unit; an operation detecting unit configured to detect, from the image capturing signal obtained by the image capturing unit, the operation of the user and an operation position at which the user performs the operation, the user wearing the medical support apparatus; a view management unit configured to manage the image capturing signal, the information on the attitude, and the information on the image capturing position in association with one another; a superimposed information constructing unit configured to determine (i) superimposed details based on the operation detected by the operation detecting unit and (ii) information on the operation position based on the image capturing signal, the information on the attitude, and the information on the image capturing position, and generate superimposed information including the superimposed details and the information on the operation position; a display management unit configured to generate a viewpoint image from the image capturing signal, generate an image by superimposing the superimposed details at the operation position on the viewpoint image, and display the image; and a communication unit configured to transmit the superimposed information to at least one other medical support apparatus.

Here, the information on the operation position is represented by a system independent from the system of the information on the attitude, the information on the image capturing position, and the operation position detected by the operation detecting unit.

With this configuration, the fixation of an eye direction and the interference to smooth operations can be reduced by sharing, among users including a doctor in a remote area, a view or an operation of at least one of the other users. Furthermore, more easy-to-follow instructions can be presented by giving advices on an affected area by the user in the remote area.

Furthermore, the communication unit may be configured to receive an image capturing signal obtained by capturing an image by the at least one other medical support apparatus, and the medical support apparatus may further include: a virtual viewpoint generating unit configured to generate virtual viewpoint information, based on an arbitrary position and information indicating respective positions of the two or more other medical support apparatuses near the arbitrary position; and an image synthesis unit configured to generate an image using the arbitrary position as a virtual viewpoint, based on the virtual viewpoint information and respective image capturing signals received from the two or more other medical support apparatuses near the arbitrary position.

With this configuration, the fixation of an eye direction and the interference to smooth operations can be reduced by sharing, among the users including the doctor in the remote area, a view or an operation of at least one of the other users. Furthermore, more easy-to-follow instructions can be presented by giving advices on an affected area by the user in the remote area.

Furthermore, the superimposed information may be managed in association with display attribute information indicating a display mode of the superimposed details included in the superimposed information, and the medical support apparatus may further include a screen adjusting unit configured to process the image generated by the display management unit by superimposing the superimposed details, according to the display attribute information.

Furthermore, it becomes possible to control the display in more details, such as enlarged display of any point in a view and setting information other than superimposed information of a specific type to a non-display mode.

Furthermore, each functional block of the medical support apparatus according to the present invention can be implemented as a program executed by a computer. Such a program can be distributed via recording media such as a CD-ROM, and transmission media such as the Internet.

Furthermore, the present invention may be implemented as a semiconductor integrated circuit device (LSI). Each of the functional blocks may be made into a single-function LSI, or a part or an entire thereof may be made into the LSI. The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. Field Programmable Gate Array (FPGA) that can be programmed after manufacturing LSI or a reconfigurable processor that allows re-configuration of the connection or configuration of an LSI can be used for the same purpose.

In the future, with advancement in semiconductor technology, a brand-new technology may replace LSI. The functional blocks can be integrated using such a technology.

### Advantageous Effects of Invention

According to the medical support apparatus of the present invention, an operation of the user in a remote area at the current time are represented in an appropriate position relationship with the actual object in front of the user, as if the user were present in the same space. In this manner, a more intuitive instruction can be given, and the cooperative work can be performed.

### BRIEF DESCRIPTION OF DRAWINGS

FIG. 1 illustrates a functional block diagram of a medical support apparatus according to Embodiment 1 of the present invention.

FIG. 2 illustrates a relationship between a medical support apparatus and the other nodes 130 in a room according to Embodiment 1.

FIG. 3 illustrates the coordinate transformation in the 3D space according to Embodiment 1.

FIG. 4 illustrates the operation detecting information issued by the operation detecting unit according to Embodiment 1.

FIG. 5 illustrates the superimposed information recorded by the superimposed information storage unit according to Embodiment 1.

FIG. 6A is a flowchart indicating processes for generating the superimposed information in response to a request from the user and displaying an image by superimposing the superimposed information on the viewpoint image according to Embodiment 1.

FIG. 6B is a flowchart indicating processes for generating the superimposed information in response to a request from the user and displaying an image by superimposing the superimposed information on the viewpoint image according to Embodiment 1.

FIG. 7 illustrates an example of images each obtained by superimposing the superimposed details on the viewpoint image according to Embodiment 1.

FIG. 8 illustrates a functional block diagram of a medical support apparatus according to Embodiment 2 of the present invention.

FIG. 9 is a flowchart indicating processes for generating a virtual viewpoint according to Embodiment 2.

FIG. 10 illustrates an example of images each obtained by superimposing the superimposed details on the viewpoint image according to Embodiment 2.

FIG. 11 illustrates an example of images each obtained by superimposing the superimposed details on the viewpoint image according to Embodiment 2.

FIG. 12 is a flowchart indicating processes for displaying a viewpoint image viewed from a viewpoint that is a virtual point according to Embodiment 2.

FIG. 13 illustrates a functional block diagram of a medical support apparatus according to Embodiment 3 of the present invention.

FIG. 14 illustrates an example of display attribute types according to Embodiment 3.

FIG. 15A illustrates an example of a display attribute according to Embodiment 3.

FIG. 15B illustrates an example of a display attribute according to Embodiment 3.

FIG. 16 is a flowchart indicating processes for reflecting a set display attribute on a display screen according to Embodiment 3.

### DESCRIPTION OF EMBODIMENTS

Embodiments of the present invention will be hereinafter described with reference to drawings.

### Embodiment 1

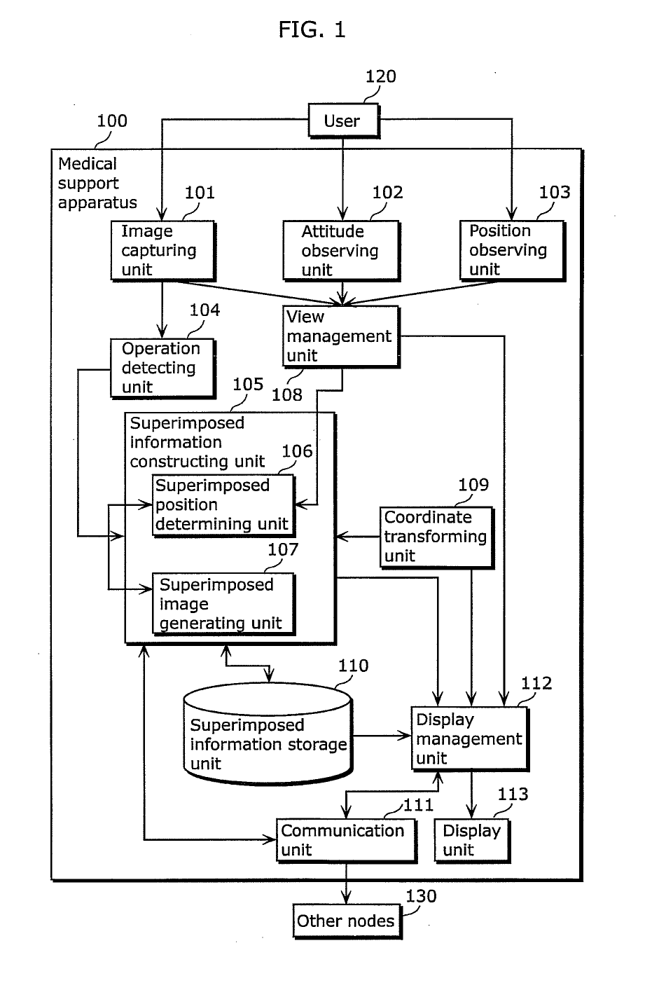

FIG. 1 illustrates a functional block diagram of a medical support apparatus according to Embodiment 1 of the present invention.

The medical support apparatus 100 is an apparatus for sharing, among users including a doctor, a view or an operation of at least one of the users, and includes an image capturing unit 101, an attitude observing unit 102, a position observing unit 103, an operation detecting unit 104, a superimposed information constructing unit 105, a view management unit 108, a coordinate transforming unit 109, a superimposed information storage unit 110, a communication unit 111, a display management unit 112, and a display unit 113. Furthermore, the superimposed information constructing unit 105 includes a superimposed position determining unit 106 and a superimposed image generating unit 107. The medical support apparatus 100 is configurable with a head-mounted display functioning as the display unit 113 and a computer including (i) a miniature camera functioning as the image capturing unit 101, (ii) a recording medium (not illustrated), such as a memory and a hard disk, which records programs each corresponding to the position observing unit 103, the operation detecting unit 104, the superimposed information constructing unit 105, the view management unit 108, the coordinate transforming unit 109, the communication unit 111, and the display management unit 112, (iii) a recording medium (not illustrated) which records a program corresponding to the superimposed information storage unit 110, such as a memory and a hard disk, and (iv) a processor that executes one of the programs recorded in the memories, such as a CPU (not illustrated). Furthermore, the medical support apparatus 100 is configurable by including all the constituent elements in the head-mounted display. The medical support apparatus 100 including part of the constituent elements will be referred to as a subset. For example, the medical support apparatus 100 that does not hold the head-mounted display that is the display unit 113 can be also referred to as a subset in the configuration example of the medical support apparatus 100. Each of other nodes 130 is equivalent to the medical support apparatus 100 or the subset in FIG. 1.

In the example above, each of the position observing unit 103, the operation detecting unit 104, the superimposed information constructing unit 105, the view management unit 108, the coordinate transforming unit 109, the communication unit 111, and the display management unit 112 is stored as a program in the recording medium, such as a memory and a hard disk, included in the computer, and the CPU executes each of the programs. However, the configuration is not limited to such, and the computer may be configured using a dedicated processing circuit (for example, LSI) in which a part or entire of the position observing unit 103, the operation detecting unit 104, the superimposed information constructing unit 105, the view management unit 108, the coordinate transforming unit 109, the communication unit 111, and the display management unit 112 is not illustrated. With employment of such a configuration, a program corresponding to an operation implemented using the dedicated processing circuit (not illustrated) does not have to be stored in a recording medium, such as a memory and a hard disk, included in the computer.

Furthermore, it is preferable that the computer is small enough to be included in the head-mounted display.

Furthermore, the computer includes a communication circuit (not illustrated) for communication (for example, transmission and reception) via a wired or wireless network.

The communication unit 111 has a configuration including the communication circuit and recording media, such as a memory and a hard disk, which records a program for controlling the communication circuit. Furthermore, an operation when the program for controlling the communication circuit is executed by the CPU may be constructed using a dedicated processing circuit that is not illustrated (for example, LSI).

With employment of such a configuration, a program for controlling the communication circuit corresponding to an operation implemented using the dedicated processing circuit (not illustrated) does not have to be stored in a recording medium, such as a memory and a hard disk, included in the computer.

Users who are different from a user 120 wear the other nodes 130. The other nodes 130 and the apparatuses to which the other nodes 130 are attached have a relationship similar to that between the user 120 and the medical support apparatus 100. Communication between each of the nodes allows sharing of a view and information to be superimposed on the view, and supporting medical work.

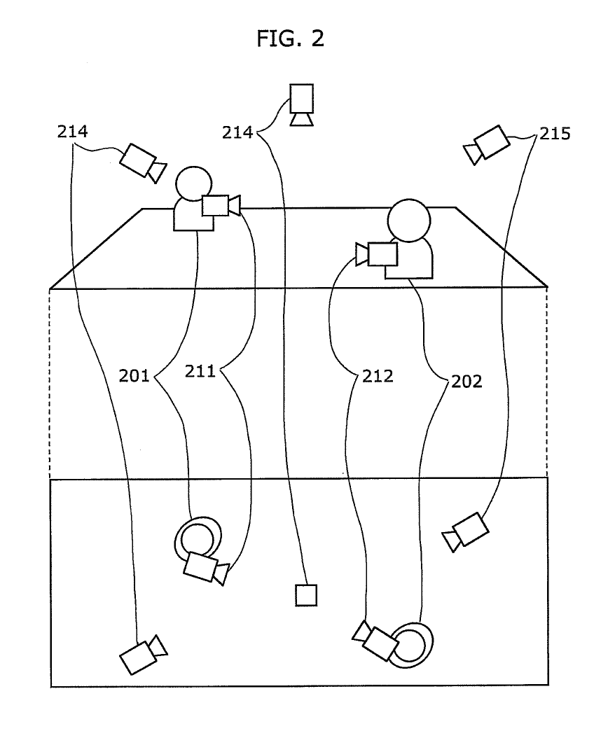

FIG. 2 illustrates a relationship between the medical support apparatus 100 and the other nodes 130 in a room. The upper portion is a view viewing the room from an obliquely upward direction, and the lower portion is a view looking down on the room from directly above. Embodiment 1 assumes an indoor operating room, and the user is assumed to be a doctor inside the room or in a remote area. An operating table for placing a patient is placed at the center of the room in FIG. 2. FIG. 2 does not illustrate the operating table for simplification.

Users 201 and 202 who are doctors each corresponding to the user 120 in FIG. 1 wear medical support apparatuses 211 and 212 each corresponding to the medical support apparatus 100, respectively. In this manner, the users 201 and 202 who are the doctors in an operating room use functions of the medical support apparatus 100, using the medical support apparatuses 211 and 212 respectively worn by the users 201 and 202.

The medical support apparatuses 213, 214, and 215 are medical support apparatuses that are not worn by the users, and are equivalent to the medical support apparatus 100 or the subset. The medical support apparatus 100 is not necessarily paired with a person who wears it. The medical support apparatuses 213, 214, and 215 can be placed at any points in the room. In Embodiment 1, the medical support apparatuses 211 to 215 are placed so as to surround the center (point at which the operating table is placed). Here, the medical support apparatus 213 is placed vertical to the ceiling, and is placed so as to entirely view the room including the medical support apparatuses 211, 212, 214, and 215 to be worn by the other users as illustrated in the lower portion of FIG. 2. Embodiment 1 is not limited to the structure in which the medical support apparatus 213 is placed so as to entirely view the room. Although the larger number of points at which images can be captured is preferable, the possible number of the medical support apparatuses can be arbitrarily specified according to a state, because increase in the number of nodes increases an amount of processing.

In the medical support apparatus 100, each of the nodes shares at least one information item, such as a character string to be displayed on the display unit 113 of the medical support apparatus 100 to be worn by the user, and the information item is superimposed on each view. Displaying the information item on each of the views means that the information item to be displayed is placed in a unique coordinate space with the origin at each of the nodes. Thus, coordinate values representing the position of the information item differs for each of the nodes, even when the information items are identical. Thus, it is necessary to manage information items in a common coordinate system to share one information item.

Furthermore, when each of the nodes represents the medical support apparatus 100 worn on the head of a person, the position of the head at each of the nodes is changed from moment to moment, according to a medical work. Thus, in order to understand the position of the head at each of the nodes per unit of time, it is also necessary to track an intrinsic coordinate system that is changed in time series. In other words, it is necessary to obtain coordinate values of a common coordinate system from coordinate values of the intrinsic coordinate system at a certain point in time, or vice versa. Here, a relationship between the intrinsic coordinate system and the common coordinate system will be described.

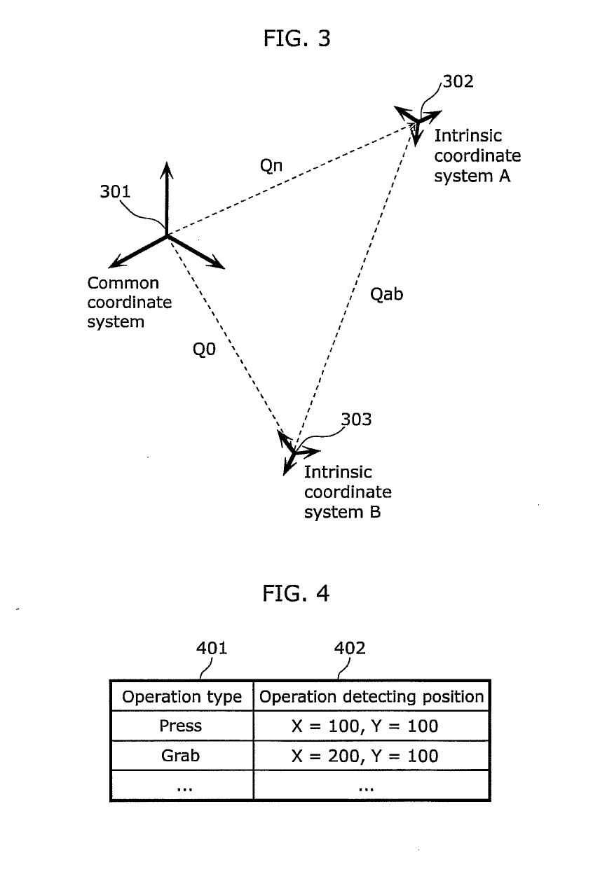

FIG. 3 illustrates the general coordinate transformation in 3D space. Assume that the user desires to know a transformation matrix Qn between a common coordinate system 301 at a certain time and an intrinsic coordinate system A302 after a lapse of N time from the certain time in FIG. 3. Here, when an intrinsic coordinate system B303 is an independent coordinate system that can freely move by itself, assume that the intrinsic coordinate system B303 overlaps with the intrinsic coordinate system A302 after the lapse of the N time of the intrinsic coordinate system B303. As illustrated, the position relationship between the intrinsic coordinate system B303 and the common coordinate system 301 is represented by a transformation matrix Q0. Furthermore, the position relationship between the intrinsic coordinate system B303 and the intrinsic coordinate system A302 after the lapse of the N time can be represented by a transformation matrix Qab, according to a parallel translation amount p and a rotation angle θ with which the intrinsic coordinate system B303 is translated to the intrinsic coordinate system A302. Here, relationships (1) Qn=Q0+Qab and (2) Qab=P(θ, p) hold.

In other words, the position relationship Qn between the intrinsic coordinate system A302 after the lapse of the N time and the common coordinate system 301 is determined by Q0 representing a position relationship between the common coordinate system 301 and an initial position of an intrinsic coordinate system (B303), the parallel translation amount p with respect to the initial position of the intrinsic coordinate system, and an amount of change in the rotation angle θ.

Next, relationships between blocks will be described with reference to the functional block diagram of the medical support apparatus according to Embodiment 1.

The image capturing unit 101 obtains an image capturing signal by capturing an image according to a view of the user. In other words, the image capturing unit 101 obtains the image capturing signal by converting an optical image in an eye direction of the user 120, or an optical image of the user 120 or a part of the user 120, into an electrical signal. The image capturing signal is input information to be fed to the operation detecting unit 104 and the view management unit 108. The operation detecting unit 104 uses the image capturing signal for detecting an operation request from the user 120 to the medical support apparatus 100. The detailed method will be described later. Furthermore, the view management unit 108 uses the image capturing signal to obtain an image in an eye direction of the user 120. Embodiment 1 assumes that the image capturing unit 101 obtains the image capturing signal from two cameras. The two cameras are worn on the head of the user 120, and are handled as respective image capturing signals from views of the left and right eyes. As long as requirements for obtaining the input information for detecting the operation request of the user 120 and an image that matches the eye direction are satisfied, the configuration is not limited to the one assumed in Embodiment 1.

The attitude observing unit 102 obtains a viewing angle that is information on an attitude of an eye direction, such as roll, pitch, and yaw angles of the user 120 who wears the medical support apparatus 100. Embodiment 1 assumes that the attitude observing unit 102 includes a sensor that can obtain the three axes angles, and is placed on the head of the user 120 who wears the medical support apparatus 100. The viewing angle is used for estimating the eye direction of the user 120.

The position observing unit 103 obtains a viewing position that is information on an image capturing position indicating a position of the head of the user 120 who wears the medical support apparatus 100. The viewing position is used for estimating a position of the user 120 in a room. For example, when the medical support apparatus 100 in FIG. 2 or the medical support apparatus 213 indicated as the subset is the standard apparatus in the room, the viewing position allows the user to understand a position of the user 120 in the room by calculating a relative position between the medical support apparatus 213 and the other medical support apparatus 100 or the subset.

The operation detecting unit 104 analyzes the image capturing signal obtained by the image capturing unit 101, and detects an operation representing an operation request of the user 120. Here, an example of the detection operation will be described. The operation detecting unit 104 extracts a body part for which the user mainly requests the operation, from the obtained image capturing signal. For example, when an operation request is detected from either hand generally used as a detection part, the generally known method is a method of estimating and recognizing the hand in the image capturing signal by extracting a skin color or extracting a curve segment, or through model matching with hand shapes held in the medical support apparatus 100 in advance. Next, the operation detecting unit 104 tracks and monitors the extracted operation part in time series. For example, when continuing to detect the hand shape of a pointing finger for a predetermined period, the operation detecting unit 104 notifies the superimposed information constructing unit 105 of the operation request as operation detecting information, assuming that it detects the operation of selecting any one of points in the image capturing signal. Each time the operation detecting unit 104 does not detect any operation representing the operation request, it analyzes the image capturing signal obtained by the image capturing unit 101, and repeats the process for detecting an operation representing an operation request. Here, the operation detecting information includes at least information indicating a type of the operation detected by the operation detecting unit 104 and information indicating a position at which an operation in the captured image is performed.

FIG. 4 illustrates an example of the operation detecting information issued by the operation detecting unit 104. The operation detecting information includes at least an operation type 401 and an operation detecting position 402. The operation type 401 is a type of an operation detected by the operation detecting unit 104, and represents an operation, such as selecting an arbitrary portion according to the operation and generating an image to be superimposed. The operation detecting position 402 is a position at which the operation detecting unit 104 detects the operation in the image captured by of the image capturing unit 101. For example, examples of the operation type 401 include a “Press” operation for pointing at an arbitrary point in a view and for selecting graphics representing a button virtually set in the view, and a “Grab” operation for grabbing graphics data for changing a position of the data displayed within the view. Furthermore, the operations include an operation of drawing graphics, such as marking. Furthermore, values of an X coordinate and a Y coordinate indicating a point at which the operation indicated by the operation type 401 in the image capturing signal are stored as the operation detecting position 402. Furthermore, information such as the other types and a Z coordinate except for the examples may be stored as the operation type 401 and the operation detecting position 402.

The superimposed information constructing unit 105 receives a notification on the operation detecting information from the operation detecting unit 104, and generates or update information on the operation. Here, the information on the operation is superimposed information including (i) information indicating a position at which the operation works, and (ii) visual information (superimposed details) when the operation is displayed on a screen. For example, the superimposed information is graphic display in text to be used for strengthening information for an arbitrary point in a view of the user 120, such as a memo, explanation, and a guide. The superimposed information storage unit 110 stores new superimposed information in response to a request for record. Furthermore, the superimposed information constructing unit 105 can notify the other nodes 130 of generating or updating of the superimposed information by transmitting the notification through the communication unit 111. Furthermore, the superimposed information constructing unit 105 notifies the display management unit 112 of updating the screen so as to reflect the generation or update of the information on the operation to the screen.

The superimposed position determining unit 106 calculates a position at which the operation indicated by the operation detecting information is performed. In order to share certain superimposed information with the other nodes 130, it is necessary to hold a coordinate position in a common coordinate system. However, the operation detecting unit 104 detects an operation representing an operation request detected by each of the medical support apparatuses 100, based on an image captured by a corresponding one of the image capturing units 101. In other words, the position detected by the operation detecting unit 104 is not based on the common coordinate system but on the coordinate system of each of the image capturing units 101, at each of the nodes. The superimposed position determining unit 106 determines coordinate values in the common coordinate system that is information on the operation position, based on the coordinate values obtained at each of the nodes in the coordinate system. Upon receipt of a request for generating the position from the superimposed information constructing unit 105, the superimposed position determining unit 106 calculates the coordinate values in the common coordinate system. Hereinafter, the procedure for calculating the coordinate values in the common coordinate system will be described. The superimposed position determining unit 106 requests the view management unit 108 to obtain viewpoint information, and obtains a viewing position and a viewing angle at the current time. Then, the superimposed position determining unit 106 calculates the coordinate values in the common coordinate system, using the obtained viewing position, the viewing angle, and the operation position detected by the operation detecting unit 104. Here, the superimposed position determining unit 106 obtains the coordinate values by requesting the coordinate transforming unit 109 to perform the coordinate transformation process.

The superimposed image generating unit 107 generates an image according to the type of the operation indicated by the operation detecting information notified from the operation detecting unit 104. For example, when the operation detecting unit 104 notifies an operation instructing to display text to be superimposed at any point within the view, the superimposed image generating unit 107 generates graphics information of the text. Upon receipt of a request for generating an image from the superimposed information constructing unit 105, the superimposed image generating unit 107 determines the type of the operation, and generates the graphics information of shape, color, characters, and size according to the operation.

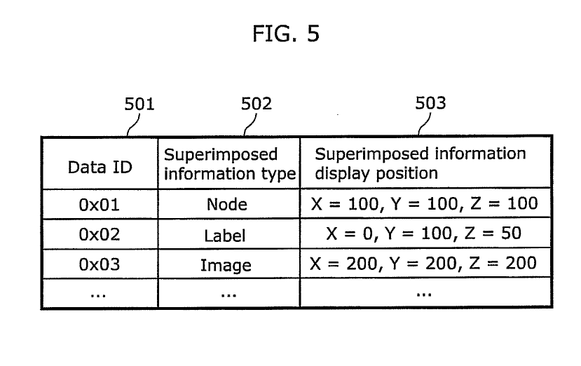

FIG. 5 illustrates an example of the superimposed information recorded by the superimposed information storage unit 110. The superimposed information includes at least a data ID 501, a superimposed information type 502, and a superimposed information display position 503. The data ID 501 is a unique code assigned to the superimposed information separately. In Embodiment 1, the unique values indicated as the data ID 501 in FIG. 5 are assigned. The superimposed information type 502 represents a type of the superimposed information. For example, when certain superimposed information represents the medical support apparatus 100 and the subset, a type of “Node” is assigned as the superimposed information type 502 in FIG. 5. Furthermore, each type of information superimposed on a view can be sorted out, for example, by assigning a type “Label” to text graphics, such as information and a memo of a patient, and a type “Image” to image data, such as an x-ray image. Furthermore, the other nodes 130 can be regarded as a type of the superimposed information for a certain node. In this case, the other nodes 130 may be managed as “Node” in the superimposed information type 502. The superimposed information display position 503 indicates a display position of the superimposed information in the common coordinate system. Here, coordinate values on X, Y, and X axes are set as the display position, as the superimposed information display position 503 in FIG. 5. Other information may be held as the superimposed information. For example, when the superimposed information is displayed in text, for example, character string information, font information, size information, color, and typeface information are held as the superimposed information display position 503. Furthermore, such information may also include shape information representing each set of vertices when the image has an arbitrary shape, information of a transmission rate, and texture image information used on the surface of the shape. Data to be processed as the superimposed information or data on display may be included as the superimposed information.

The view management unit 108 obtains and distributes the viewpoint information at the current time. In Embodiment 1, the view management unit 108 obtains and distributes, as the viewpoint information, an image viewed from a viewpoint (viewpoint image), angles of three X, Y, and X axes (roll, pitch, and yaw angles) in a viewpoint of the intrinsic coordinate system (viewing angles), and coordinate values in the three X, Y, and X axes (viewing position). The view management unit 108 obtains an image viewed from a viewpoint (viewpoint image), from the image capturing unit 101. The view management unit 108 obtains the angles of the three X, Y, and X axes (viewing angles) in the viewpoint of the intrinsic coordinate system from the attitude observing unit 102. The view management unit 108 obtains the coordinate values in the three X, Y, and X axes (viewing position) in the viewpoint of the intrinsic coordinate system from the position observing unit 103. Upon receipt of requests for obtaining at least one or more of the viewpoint image, the viewing angles, and the viewing position, the view management unit 108 notifies the requested information as the viewpoint information. In Embodiment 1, the superimposed position determining unit 106 requests the obtainment of the viewpoint information. What the view management unit 108 obtains and distributes is not necessarily the viewpoint image, the viewing angles, and the viewing position. The information may be at least one of these, or may be information from another viewpoint. Examples of the information from another viewpoint include, for example, depth information from a viewpoint using a depth sensor, and special ray information on infrared rays.

The coordinate transforming unit 109 transforms or inversely transforms the common coordinate system into a coordinate system at each of the nodes. For example, the superimposed position determining unit 106 sets values (p, θ) to satisfy the equations (1) and (2) to the coordinate transforming unit 109, based on the viewing position and the attitude information at the time when they are obtained from the view management unit 108. The coordinate transforming unit 109 performs the coordinate transformation process by applying the position relationship Q0 between the initial position of each of the nodes and the intrinsic coordinate system.

The superimposed information storage unit 110 stores the coordinate values in the common coordinate system of the superimposed information generated by the superimposed position determining unit 106, and the superimposed information, such as the image information generated by the superimposed image generating unit 107 in response to a request for generating the image. The superimposed information storage unit 110 records the superimposed information, in response to the request for updating the information from the superimposed information constructing unit 105. The recorded superimposed information is obtained by the display management unit 112, and is used for generating a display screen to be displayed by the display unit 113.

The communication unit 111 communicates with the other nodes 130. The communication unit 111 receives a notification request for generating and updating the superimposed information from the superimposed information constructing unit 105, and notifies the other nodes 130 of the request. Furthermore, the communication unit 111 that receives the notification notifies the superimposed information constructing unit 105 of the details of the notification. Accordingly, the communication unit 111 mutually communicates with the other nodes 130.

The display management unit 112 receives the notification for updating the screen from the superimposed information constructing unit 105, and constructs the screen. The screen to be displayed includes the superimposed information stored in the superimposed information storage unit 110, and an image viewed from the current viewpoint. The display management unit 112 requests the view management unit 108 to obtain the viewpoint information, and obtains a left-eye image and a right-eye image at the current viewpoint. The display management unit 112 obtains the viewing position and the viewing angle in the common coordinate system, from the superimposed information storage unit 110. Furthermore, the display management unit 112 calculates a field of view based on the viewing position and the viewing angle in the common coordinate system, and obtains the superimposed information in the field of view from the superimposed information storage unit 110. The display management unit 112 places the coordinate values of the obtained superimposed information, in a coordinate system for each of the nodes, using the coordinate transforming unit 109, and generates the image to be superimposed on the current viewing image. Furthermore, the display management unit 112 requests the display unit 113 to superimpose the generated image on the left-eye image and the right-eye image that form the viewing image and are obtained from the view management unit 108, and display the resulting image.

The display unit 113 receives the request for displaying the image on the screen from the display management unit 112, superimposes the image obtained from the superimposed information on the left-eye image and the right-eye image, and displays the resulting image.

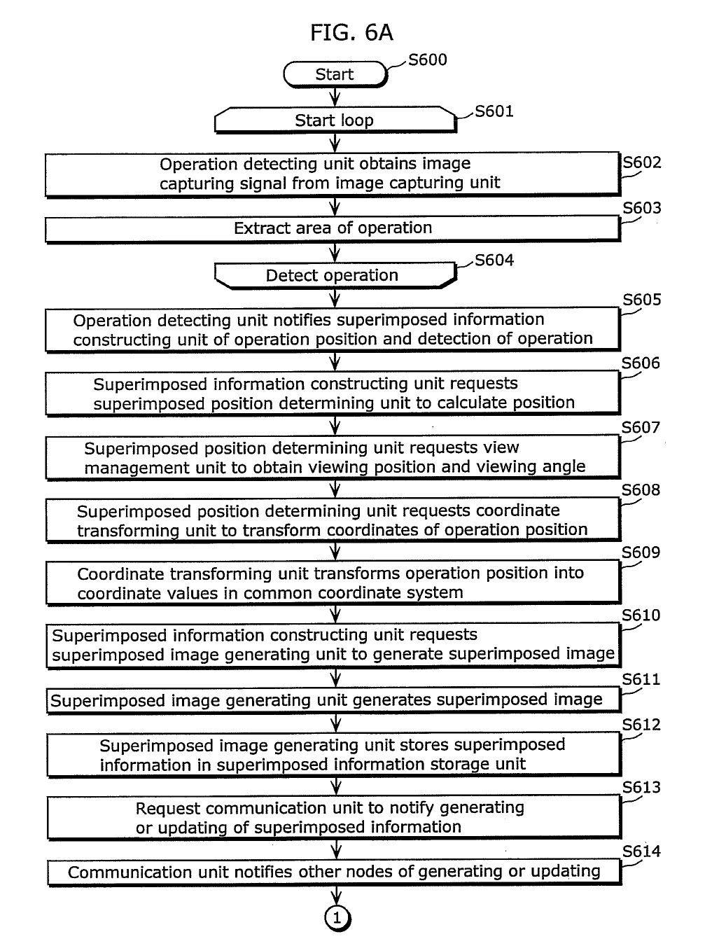

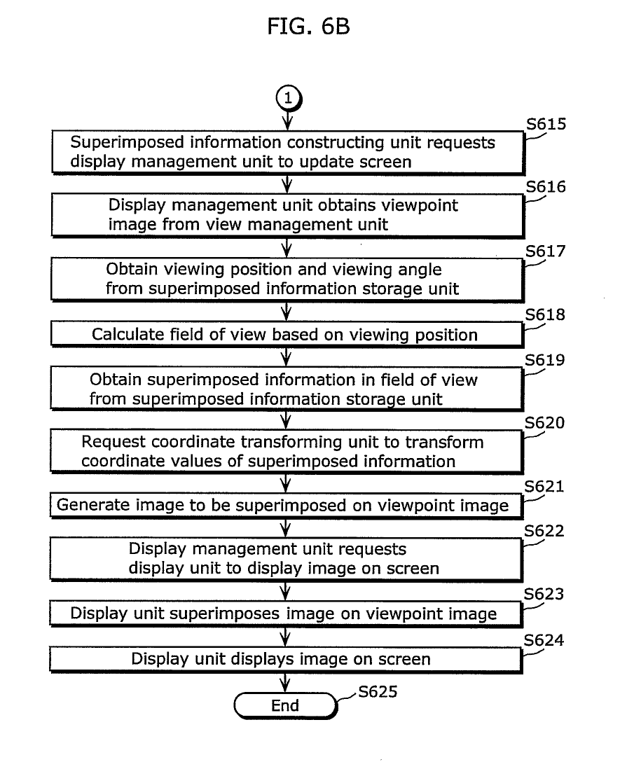

FIGS. 6A and 6B are flowcharts each indicating processes in which the medical support apparatus 100 in FIG. 1 generates the superimposed information in response to a request from the user 120, and displays an image by superimposing the superimposed details on the viewing image.

First, the processes start (S600), and a detecting process for performing an operation representing the operation request from the user 120 starts (S601). In the detecting process, the operation detecting unit 104 first obtains an image capturing signal from the image capturing unit 101 (S602).

The operation detecting unit 104 extracts an area of the operation in response to the operation request from the user 120, from the obtained image capturing signal (S603). In Embodiment 1, the area of the operation is assumed to be either hand. The generally known method is a method of estimating and recognizing the hand in the image capturing signal by extracting a skin color or extracting a curve segment. Here, the extracted area of the operation is not limited to the hand. For example, a part of the body of the operator other than the hand, such as an eye direction of the user 120 and a tool such as a knife held by the user in the hand, may be extracted as an area of the operation, and used for recognizing the operation.

Next, the operation detecting unit 104 monitors the extracted area of the operation (S604). When detecting the operation representing the operation request, the operation detecting unit 104 notifies the superimposed information constructing unit 105 of the operation detecting information as well as the position at which the operation in the image capturing signal is detected (S605).

Each time the operation detecting unit 104 does not detect any operation representing the operation request, the processes return to the process for obtaining the image capturing signal from the image capturing unit 101, and are repeated until the process representing the operation request is detected.

The superimposed information constructing unit 105 that receives the notification of the operation detecting information requests the superimposed position determining unit 106 to calculate a position in order to determine coordinate values at the operation position received from the operation detecting unit 104, in the common coordinate system (S606).

The superimposed position determining unit 106 that receives the request requests the view management unit 108 to obtain the viewing position and the viewing angle at the current time (S607).

The superimposed position determining unit 106 notifies the coordinate transforming unit 109 of the obtained viewing position and viewing angle and the operation position notified from the operation detecting unit 104, and requests the coordinate transforming unit 109 to transform the operation position into common coordinate values (S608).

Let p be the viewing position and θ be the viewing angle, the coordinate transforming unit 109 calculates the coordinate values in the common coordinate system by determining the transformation matrix Qn using (p, θ) that satisfies the equations (1) and (2) (S609). Here, the viewing position and the viewing angle are obtained from the view management unit 108.

The superimposed information constructing unit 105 requests the superimposed image generating unit 107 to generate a superimposed image to be displayed on the operation position received from the operation detecting unit 104 (S610).

The superimposed image generating unit 107 generates the superimposed image according to the operation type 401 of the operation detecting information notified from the operation detecting unit 104, with reference to the operation type 401 (S611). Here, when the superimposed information is displayed in text, the superimposed image generating unit 107 can generate the superimposed image using the character string information, the font information, the size information, the color, and the typeface information described in FIG. 5.

The order of the processes for determining a superimposed position S606 to S609 and the processes for generating a superimposed image S610 to S611 will be any as long as the processes satisfy the requirements for preparing elements that construct the superimposed information.

The superimposed information constructing unit 105 generates the superimposed information in FIG. 5, using the operation position calculated by the superimposed position determining unit 106 and the graphics information such as text to be superimposed on any point within the view. The superimposed information constructing unit 105 updates the generated superimposed information and stores the information in the superimposed information storage unit 110 (S612).

In order to reflect such generating and updating to the other nodes 130, the superimposed information constructing unit 105 requests the communication unit 111 to notify the generating or updating of the superimposed information (S613).

Upon receipt of the notification, the communication unit 111 issues the superimposed information and the notification of the generating or updating of the superimposed information, to the other nodes 130 (S614). Here, the communication unit 111 of each of the other nodes 130 that receive the notification of the generating or updating notifies the superimposed information constructing unit 105 to update the superimposed information. The superimposed information constructing unit 105 records the generated or updated superimposed information in the superimposed information storage unit 110. As long as the requirements for updating the superimposed information are satisfied for the other nodes 130, other schemes, paths, and methods may be used.

Next, the superimposed information constructing unit 105 requests the display management unit 112 to update a screen (S615).

The display management unit 112 places the actual image viewed from the viewpoint and the superimposed image to be superimposed on the actual image to update the display screen. The display management unit 112 obtains the left-eye image and the right-eye image from the view management unit 108 (S616).

The display management unit 112 obtains the viewing position and the viewing angle in the common coordinate system that are recorded in the superimposed information storage unit 110 (S617).

The display management unit 112 calculates a field of view based on the obtained viewing position and viewing angle in the common coordinate system, for example, using the perspective projection (S618).

Furthermore, the display management unit 112 determines whether or not the common coordinate values of the superimposed information recorded in the superimposed information storage unit 110 are present in the field of view calculated by the display management unit 112, and obtains only the superimposed information fit in the field of view, from the superimposed information storage unit 110 (S619).

Since the position coordinates of the obtained superimposed information are coordinate values in the common coordinate system, the display management unit 112 transforms, using the coordinate transforming unit 109, the coordinate values of the obtained superimposed information into those of the intrinsic coordinate system for each of the nodes (S620).

The display management unit 112 places the superimposed image indicated by the superimposed information at the position indicated by the coordinate values transformed into the intrinsic coordinate system, on the display screen, and generates the image to be superimposed on the current viewpoint image (S621).

The display management unit 112 requests the display unit 113 to superimpose the generated image on the left-eye image and the right-eye image that form the viewpoint image and are obtained from the view management unit 108, and display the resulting image on the screen (S622).

Upon receipt of the request from the display management unit 112, the display unit 113 superimposes the image on the viewpoint image (S623).

Then, the display unit 113 displays one image obtained by the superimposition on the screen (S624). As described above, the processes in which the medical support apparatus 100 generates the superimposed information upon receipt of a request from the user 120, superimposes the superimposed image on the viewpoint image, and displays the screen end (S625). As described above, the one screen obtained by the superimposition may be transmitted to a display apparatus (not illustrated) used through the communication unit 111 by a doctor who is at another node or in a remote area.

Next, operations when the communication unit 111 issues the notification of the generating or updating of the superimposed information to the other nodes 130 (S614) and the other nodes 130 receive the notification will be described hereinafter. The constituent elements of the other nodes 130 are the same as those of the medical support apparatus 100, and thus denoted by the same reference numerals in the description.

The communication unit 111 at one of the other nodes 130 that receives the notification of the generating or updating of the superimposed information notifies the superimposed information constructing unit 105 of the generating or updating. The superimposed information constructing unit 105 records the generated or updated superimposed information in the superimposed information storage unit 110.

With the process for requesting to update the screen by the superimposed information constructing unit 105 (S615) to the displaying process by the display unit 113 (5624) as described above, the superimposed image based on the superimposed information received from the user 120 is superimposed on the viewpoint image at the node 130, and the resulting image is displayed.

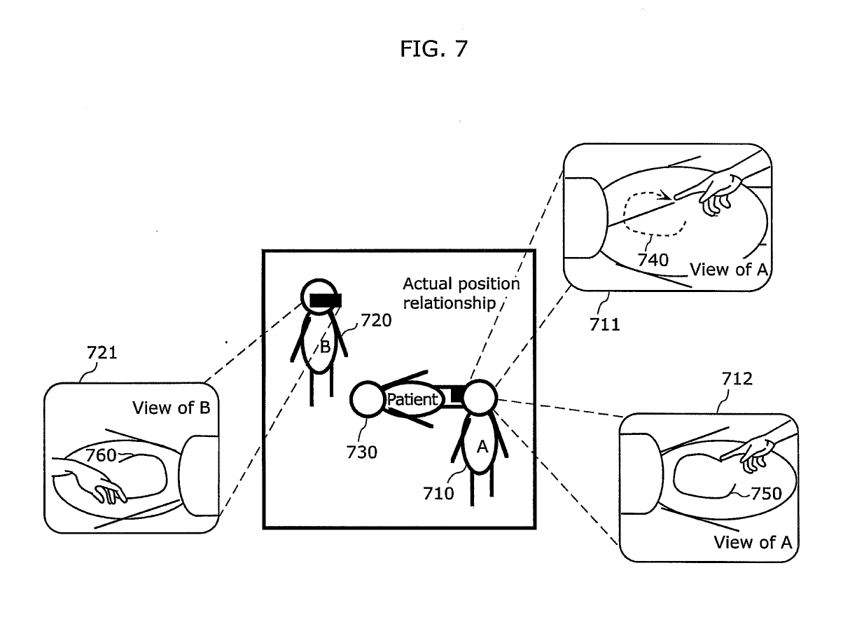

FIG. 7 illustrates an example in which the medical support apparatus 100 displays an image obtained by superimposing the superimposed details on the viewpoint image.

Assume herein a case where a user A710 who wears the medical support apparatus 100 and a user A720 who wears the node 130 stand across a patient 730 as illustrated in FIG. 7. For example, when the user A710 selects a marker and moves one of the fingers on a part of the body of the patient 730 as indicated by a dotted line 740 in a view 711 of the user A710, the display unit 113 of the medical support apparatus 100 worn by the user A710 displays a superimposed image obtained by superimposing the graphics indicating a marker 750 according to the movement of the finger indicated by the dotted line 740, on the viewpoint image of the user A710 as illustrated in the view 712 of the user A710. On the other hand, the display unit 113 of the medical support apparatus 100 worn by the user B720 displays a superimposed image obtained by superimposing the graphics indicating a marker 760 according to the movement of the finger indicated by the dotted line 740, on the viewpoint image of the user B720 as illustrated in the view 721 of the user B720.

As described above, the users can share the operations by transmitting, from the medical support apparatus or the subset worn by each of the users, the superimposed information for generating an image obtained by superimposing additional information on an image of an object within the view of the user. Furthermore, since the users can share a view or an operation of at least one of the users at the medial setting, with the viewpoint of the user by transmitting the superimposed information and a viewpoint image, it is possible to accurately support the medical work from a remote area.

### Embodiment 2

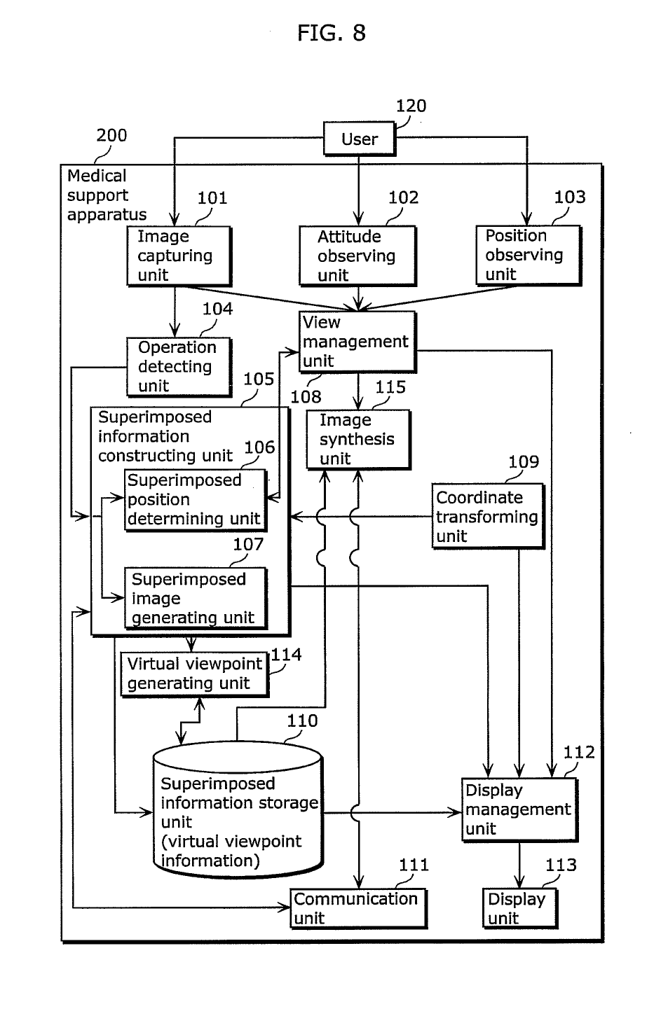

FIG. 8 illustrates a functional block diagram of a medical support apparatus according to Embodiment 2 of the present invention. In FIG. 8, the same constituent elements as those in FIG. 1 are denoted by the same reference numerals, and the description thereof is omitted. In FIG. 8, a medical support apparatus 200 includes a virtual viewpoint generating unit 114 and an image synthesis unit 115 in addition to the blocks denoted by the same reference numerals as those in FIG. 1. With the configuration, operations of people in a remote area at the current time are represented in an appropriate position relationship with the actual object in front of the user, as if the people were present in the same space in a room where the medical support apparatus 200 and the subset are placed. In this manner, a more intuitive instruction can be given, and the cooperative work can be performed.

Next, relationships between blocks will be described with reference to the functional block diagram of the medical support apparatus according to Embodiment 2.

The virtual viewpoint generating unit 114 generates a virtual viewpoint that is a virtual point using any point in the space at which the medical support apparatus 200 and the subset are placed. The superimposed information constructing unit 105 requests the virtual viewpoint generating unit 114 to generate a virtual viewpoint. The virtual viewpoint generating unit 114 obtains the superimposed information recorded in the superimposed information storage unit 110 to generate the virtual viewpoint. The virtual viewpoint generating unit 114 generates the virtual viewpoint from the obtained superimposed information. The specific example of the process for generating the virtual viewpoint will be described later. The virtual viewpoint generating unit 114 requests the superimposed information storage unit 110 to record the generated virtual viewpoint. Here, when the virtual viewpoint generating unit 114 generates the virtual viewpoint, the superimposed information constructing unit 105 sets a virtual viewpoint display to the view management unit 108. The virtual viewpoint display set by the view management unit 108 becomes a flag that distinguishes the operation request process by the user described in Embodiment 1 from the virtual viewpoint setting operation. The virtual viewpoint is handled as a kind of the superimposed information. More specifically, the virtual viewpoint is a virtual viewpoint obtained by setting a flag indicating a virtual node to the superimposed information type 502. Here, the superimposed information holds the row of the data ID 501 indicating the neighboring nodes. This is because the superimposed information is used for generating an image from a virtual viewpoint to be described later. In Embodiment 2, the viewpoint image that is virtually present is generated by synthesizing node images. Here, the neighboring nodes are used as the nodes. The superimposed information holds the data ID 501 to identify the neighboring nodes to be referred to.

The image synthesis unit 115 generates a viewpoint image from a virtual viewpoint. The viewpoint image from the virtual viewpoint is used as the viewpoint image obtained by the display management unit 112 from the view management unit 108. This is the case where the virtual viewpoint mode is set to the view management unit 108. In other words, the view management unit 108 switches between the image capturing signal from the image capturing unit 101 and the viewpoint image from the virtual viewpoint that is generated by the image synthesis unit, according to the presence or absence of the virtual viewpoint mode to generate the viewpoint image. Since the image synthesis unit 115 needs to obtain respective viewpoint images from the other nodes 130 to generate the viewpoint image from the virtual viewpoint, it obtains the respective viewpoint images from the other nodes 130 through the communication unit 111.

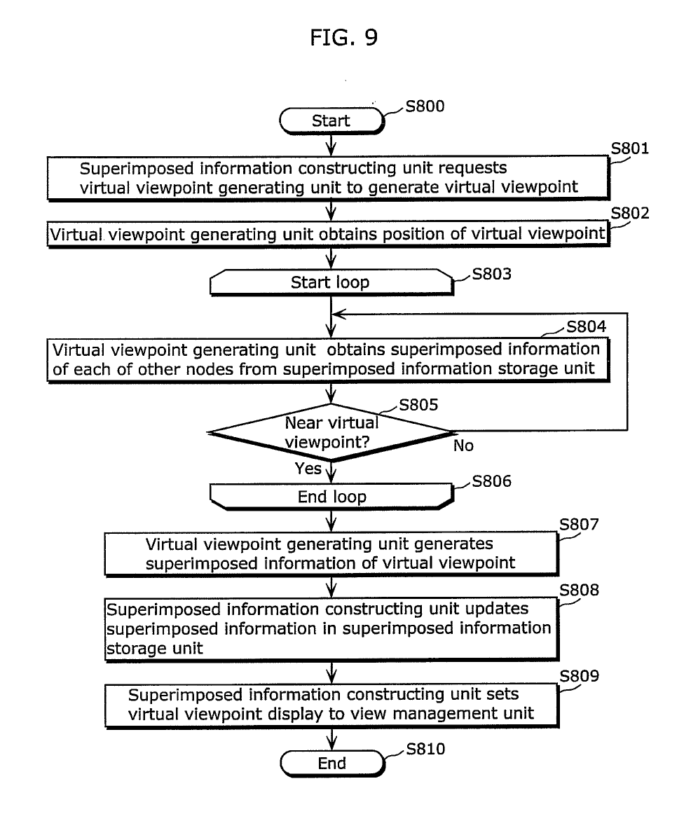

FIG. 9 is a flowchart indicating the processes for generating the virtual viewpoint by the medical support apparatus 200 according to Embodiment 2.

In Embodiment 2, the user 120 is a user in a remote area to describe the procedure for generating the virtual viewpoint. The user 120 in the remote area wears the medical support apparatus 200 in the same manner as the previously described user. The user 120 inputs an operation request for generating the virtual viewpoint into the medical support apparatus 200 in the same procedure as the processes for detecting an operation (S600 to S606) in FIG. 6A according to Embodiment 1. The superimposed information constructing unit 105 receives the operation position detected by the operation detecting unit 104 as a position at which the virtual viewpoint is generated (S800). Hereinafter, an example of a method of specifying a virtual viewpoint will be described. Displaying an image from a node 213 at which an entire of the image inside the room can be captured as illustrated in FIG. 2 results in display of a screen as if a bird's eye view of the current point was taken. The position of the virtual viewpoint can be set by selecting a desired point from the displayed screen. Without being limited to this method, as long as the requirements for the user to set any point are satisfied, the virtual position may be specified according to the other methods in the presentation method and the setting method.

The superimposed information constructing unit 105 requests the virtual viewpoint generating unit 114 to generate the virtual viewpoint (S801).

The virtual viewpoint generating unit 114 that receives the request obtains position information of the virtual viewpoint from the superimposed information constructing unit 105 (S802).

The virtual viewpoint generating unit 114 searches the other nodes 130 that are neighboring nodes for the obtained position information of the virtual viewpoint to synthesize the image from the virtual viewpoint with the image capturing signals at the other nodes to generate a synthesized image (S803).

The virtual viewpoint generating unit 114 obtains data having “Node” as the superimposed information type 502 from the superimposed information storage unit 110, one by one (S804). In Embodiment 2, since the image from the virtual viewpoint is synthesized with the image capturing signals at the other nodes to generate a synthesized image, the virtual viewpoint generating unit 114 has only to obtain the superimposed information having a code representing “Node” as the superimposed information type 502.

The virtual viewpoint generating unit 114 calculates a distance to the position information of the virtual viewpoint with reference to the superimposed information display position 503 of the obtained superimposed information, and determines a neighboring degree (S805). The reason why the neighboring nodes are detected is for determining a node that is a basis for the viewpoint image when the viewpoint image from the virtual viewpoint is generated. Generally, image based rendering is known as a method relying on images captured from a plurality of viewpoints and generating an image using an intermediate viewpoint among the viewpoints. The intermediate viewpoint is the virtual viewpoint according to Embodiment 2, and it is necessary to detect the neighboring other nodes 130 to generate the image from the virtual viewpoint. Here, the distance value to be a threshold may be one or more values selected from among the values that are being searched and the closest to the virtual viewpoint. Furthermore, a predetermined fixed value may be used as the distance value. Furthermore, any value may be set by the user. Furthermore, it is probable that the position set as the virtual viewpoint may overlap a fixed node, such as the nodes 214 and 215. In such a case, there is no need to search for the neighboring nodes. One of the nodes such as the nodes 214 and 215 is selected so that the view image at the selected node can be obtained. Furthermore, since the superimposed information display position 503 of the obtained superimposed information obtained from the superimposed information storage unit 110 is represented by coordinate values in the common coordinate system, and there are cases where the superimposed information display position 503 is different from the position of the virtual viewpoint input by the user 120. In such a case, in the same manner as S608 in FIG. 6A, the coordinate space can be unified using the coordinate transforming unit 109, and the distances to the respective nodes can be determined.

The virtual viewpoint generating unit 114 repeats the determination process until a node near the virtual viewpoint is detected in the superimposed information of the nodes that is recorded in the superimposed information storage unit 110 (S806).

The virtual viewpoint generating unit 114 generates the superimposed information including a group of the data IDs 501 of the superimposed information of the nodes near the detected virtual viewpoint, and the position information of the virtual viewpoint in the common coordinate system (S807). The superimposed information type 502 of the superimposed information is generated as a type “Virtual node”.

The superimposed information storage unit 110 records the generated superimposed information via the superimposed information constructing unit 105 (S808).

The superimposed information constructing unit 105 sets the view management unit 108 to the virtual viewpoint display (S809).

As described above, the processes for generating the virtual viewpoint as the superimposed information end (S810).

Then, the processes for notifying the other nodes 130 (S613 to S614) are performed as indicated in FIG. 6A according to Embodiment 1.

The communication unit 111 at one of the other nodes 130 that receives the notification of the generating or updating of the superimposed information notifies the superimposed information constructing unit 105 of the generating or updating. The superimposed information constructing unit 105 records the generated or updated superimposed information in the superimposed information storage unit 110. As indicated in FIG. 6B according to Embodiment 1, the processes from requesting update of a screen by the superimposed information constructing unit 105 (S615) to displaying by the display unit 113 (S624) allows displaying of the user 120 in the remote area, at the position of the virtual viewpoint at each of the other nodes 130.

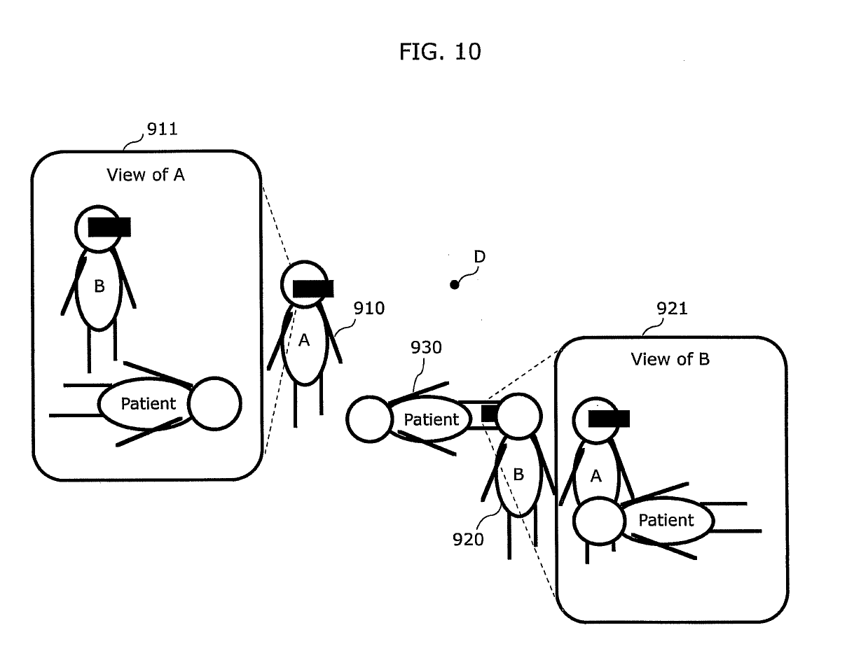

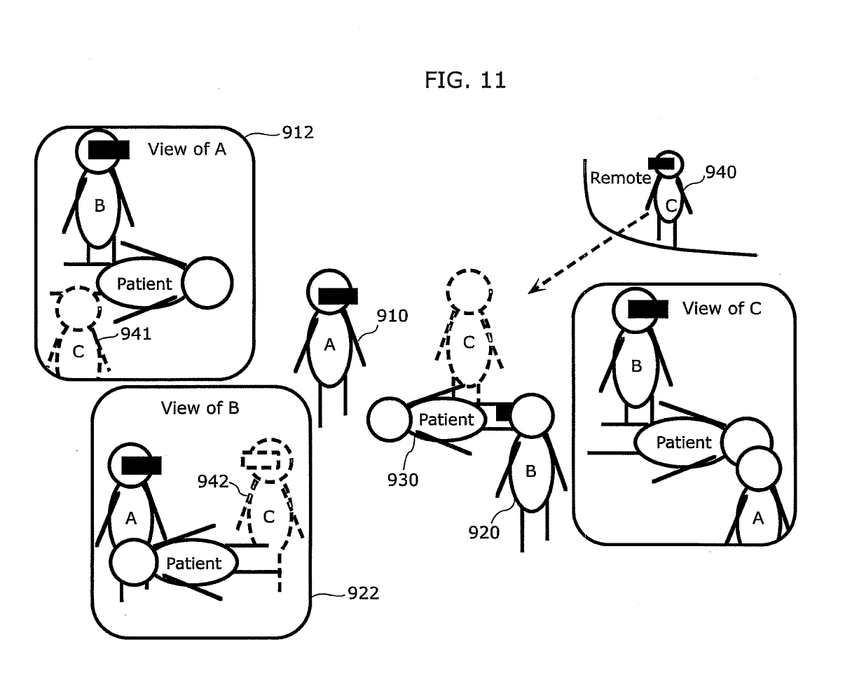

FIGS. 10 and 11 illustrate an example in which the medical support apparatus 200 displays images each obtained by superimposing the superimposed details on the viewpoint image.

Assume herein a case where a user A910 who wears the medical support apparatus 200 and a user B920 who wears the medical support apparatus 200 stand across a patient 930 as illustrated in FIG. 10, and a user C940 who wears the medical support apparatus 200 is present in a remote area. Before setting the virtual viewpoint, a viewpoint image of the user A910 is displayed on the display unit 113 of the medical support apparatus 200 worn by the user A910, as illustrated by a view 911 of the user A910. On the other hand, a viewpoint image of the user B920 is displayed on the display unit 113 of the medical support apparatus 200 worn by the user B920, as illustrated by a view 921 of the user B920.

Then, when the user C940 selects, for example, a point D in FIG. 10 as the virtual point, a superimposed image obtained by superimposing the graphics representing the user C940 by a dotted line 941 as illustrated in a view 912 of the user A910, on the viewpoint image of the user A910 is displayed on the display unit 113 of the medical support apparatus 200 worn by the user A910, using the superimposed information indicating the virtual viewpoint transmitted from the medical support apparatus 200 worn by the user C940, as illustrated in FIG. 11. On the other hand, a superimposed image obtained by superimposing the graphics representing the user C940 by a dotted line 942 as illustrated in a view 922 of the user B920, on the viewpoint image of the user B920 is displayed on the display unit 113 of the medical support apparatus 200 worn by the user B920, similarly using the superimposed information indicating the virtual viewpoint transmitted from the medical support apparatus 200 worn by the user C940.

As described above, the virtual viewpoint can be handled in the same manner as the other superimposed information by registering it as the superimposed information. Furthermore, those who set the virtual viewpoint can inform the movement of the body, such as the movement of the own hands to the users in a remote area. In other words, aside from the process for detecting the operation in the procedure indicated in FIGS. 6A and 6B, nodes of a virtual viewpoint continues to be recorded as the superimposed information in real time, by always tracking information, such as positions of the hands and fingers. Accordingly, it is possible to continuously display images of a person in a remote area for the person who is giving medical treatment on site, as if cooperative work were performed on site.

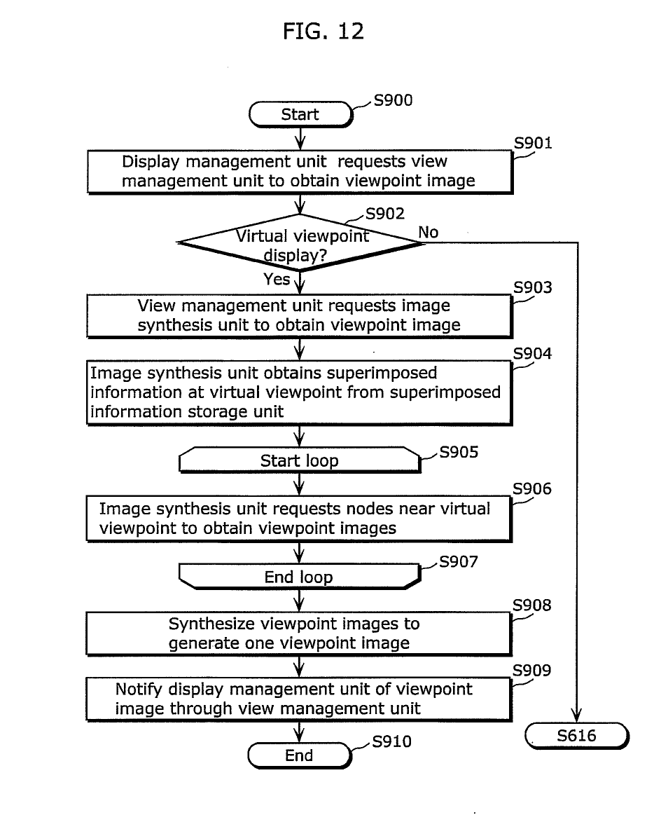

FIG. 12 is a flowchart indicating the processes for displaying a viewpoint image from a virtual viewpoint by the medical support apparatus 200 in FIG. 8.

First, in the same manner as the processes for detecting an operation (S600 to S606) in FIG. 6A according to Embodiment 1, the user operation and others are detected. Then, the same processes as those in the flowchart of FIG. 9 are performed to generate the virtual viewpoint. Furthermore, in order to reflect the processes to the display screen that is the display unit 113, the display management unit 112 is requested to update the screen (S900).

The display management unit 112 requests the view management unit 108 to obtain the viewpoint image to generate an updated screen (S901).

The view management unit 108 that receives the request determines a setting state by checking whether or not the superimposed information constructing unit 105 sets the virtual viewpoint display to the view management unit 108, through the process for setting the virtual viewpoint display (S809) as described above. The current node is a node at the virtual viewpoint, and the virtual viewpoint display is set to the view management unit 108 through the process for setting the virtual viewpoint display (S809). Thus, the view management unit 108 determines that the virtual viewpoint display is set (S902). Here, the case where the virtual viewpoint display is not set to the view management unit 108 is a case where the view management unit 108 receives a request for an operation other than the operation of setting the virtual viewpoint display. The flowcharts in FIGS. 6A and 6B according to Embodiment 1 fall under this case. The processes when the virtual viewpoint display is not set to the view management unit 108 are the same as the processes after S616.

The view management unit 108 does not obtain a viewpoint image in front from the image capturing unit 101 but requests the image synthesis unit 115 to obtain a viewpoint image because the view management unit 108 is set to the virtual viewpoint display (S903).

The image synthesis unit 115 obtains the superimposed information at the virtual viewpoint from the superimposed information storage unit 110 (S904).

As described in the process (S807), the superimposed information at the virtual viewpoint includes the group of the data IDs 501 of the superimposed information of the nodes near the virtual viewpoint. The image synthesis unit 115 identifies the medical support apparatus 200 indicated by the data ID 501 of the superimposed information near the virtual viewpoint, and the subset (S905), and requests the communication unit 111 to obtain the viewpoint images at the other nodes 130 identified near the virtual viewpoint (S906). The process for obtaining the viewpoint image is repeated for the recorded group of the data IDs 501 of the superimposed information of the nodes near the virtual viewpoint (S907). Although the communication unit 111 at one of the other nodes 130 that receives the request obtains the viewpoint image according to the request in Embodiment 2, as long as the requirements for obtaining the viewpoint image are satisfied, the communication methods between the nodes, such as wired or wireless communication, are not limited.

Next, the image synthesis unit 115 synthesizes the obtained viewpoint images at the other nodes 130 to generate one viewpoint image (S908). When the virtual viewpoint overlaps a fixed node, such as the nodes 214 and 215 as described for the process of S806, the viewpoint image at the virtual viewpoint may be used as it is. When a plurality of viewpoint images at the other nodes 130 is present, a viewpoint image from the virtual viewpoint is generated through the 3D modeling using the technique of image based rendering.

The image synthesis unit 115 notifies the view management unit 108 of the generated viewpoint image, and the display management unit 112 obtains the viewpoint image (S909). Since the view management unit 108 and the display management unit 112 receive the viewpoint image irrespective of whether or not the viewpoint image is at a virtual viewpoint, after the process S909, the screen is displayed according to the same procedure as in FIG. 6B in Embodiment 1 (S910).

As described above, the medical support apparatuses and the subsets worn by a plurality of users generate and transmit, in a coordinated manner, images viewed from respective viewpoints so that the views and operations from the respective viewpoints can be shared at the medial setting. Thus, it becomes possible to accurately support the medical work in a remote area.

### Embodiment 3

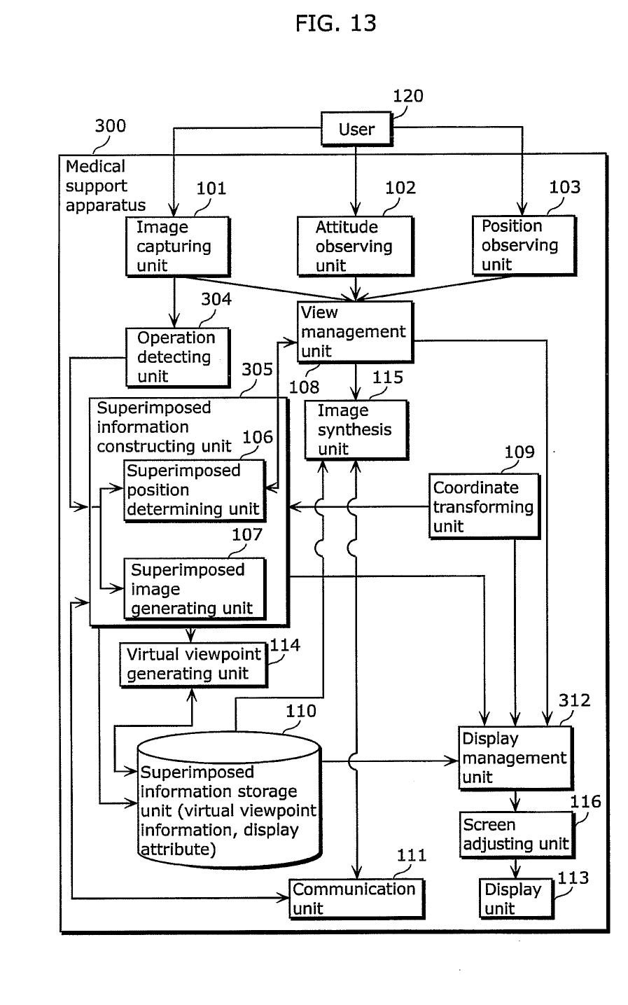

FIG. 13 illustrates a functional block diagram of a configuration of a medical support apparatus 300 according to Embodiment 3 of the present invention. The relationship between blocks will be described with reference to FIG. 13. In FIG. 13, the same constituent elements as those in FIGS. 1 and 8 are denoted by the same reference numerals, and the description thereof is omitted. Furthermore, the medical support apparatus 300 includes a screen adjusting unit 116 in addition to the blocks denoted by the same reference numerals as those in FIGS. 1 and 8.

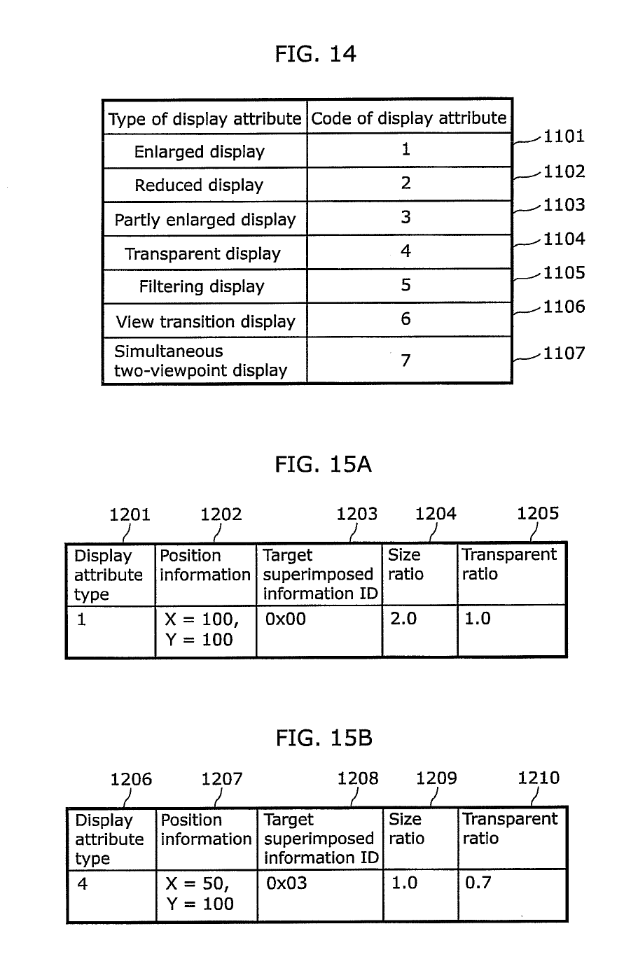

In addition to the functions of the operation detecting unit 104 in FIGS. 1 and 8, an operation detecting unit 304 recognizes an operation to which a type of a display attribute in FIG. 14 can be separately set, regarding the operations representing the request operations by the user 120. The operation detecting unit 304 notifies the superimposed information constructing unit 105 of the recognized operation type 401 as the operation detecting information.

In addition to the functions of the superimposed information constructing unit 105 in FIGS. 1 and 8, the superimposed information constructing unit 305 generates a code representing a display attribute. The superimposed information constructing unit 305 generates a display attribute corresponding to an operation, with reference to the operation detecting information notified from the operation detecting unit 304, and stores the display attribute in the superimposed information storage unit 110.

In addition to the functions of the display management unit 112 in FIGS. 1 and 8, a display management unit 312 obtains the display attribute information from the superimposed information storage unit 110. The display management unit 312 constructs a display screen according to the code represented by the display attribute, and requests the screen adjusting unit 116 to adjust the screen.

The screen adjusting unit 116 processes the display screen according to the display attribute. Upon receipt of the request for generating the virtual viewpoint from the superimposed information constructing unit 305, the screen adjusting unit 116 processes the display screen according to the code represented by the display attribute. With the configuration, each of the users 120 can specify, for the medical support apparatus 300 worn by the user 120, how to process the view image, such as enlarged display of any point in a view and setting the information other than superimposed information of a specific type to a non-display mode.

FIG. 14 illustrates the variation of the type of the display attribute in which the information stored as a display attribute in the superimposed information storage unit 110 is configured. The type of the display attribute is denoted by a code representing how to display. The display management unit 312 and the screen adjusting unit 116 refer to the type of the display attribute to process the screen, so that a screen desired by the user 120 can be displayed. Each type of the display attributes will be described hereinafter. An enlarged display 1101 and a reduced display 1102 are display attributes for displaying an enlarged image and a reduced image of a part or an entire of the screen to be displayed, respectively. The display method is useful when an operation requiring more than vision standards is performed. A partly enlarged display 1103 that is an enlarged display of a part of a viewpoint image similar to the enlarged display 1101 belongs to a display attribute that allows enlarged display of only a part of an image using a magnifying glass. This display method is useful when a portion is enlarged and displayed while checking the position relationship with a view image other than the enlarged portion. In particular, when a medical practice, such as an operation, is conducted, the partly enlarged display 1103 is available for checking an affected area for the first time. A transparent display 1104 and a filtering display 1105 belong to display attributes which separate the superimposed information into a portion desired to be displayed only at the time, a portion desired not to be displayed, and a portion subject to a transparent display. There are cases where a portion that should be viewed in the original view is hidden as long as information is superimposed on a view. The transparent display 1104 and the filtering display 1105 can be displayed in a display method that can be easily viewed by each individual. A view transition display 1106 and a simultaneous two-viewpoint display 1107 belong to display attributes in each of which a view is shared with one of the other nodes 130. As long as the operation is a cooperative operation, a plurality of cooperating workers work from respective viewpoints. The operation of each of the cooperating workers is estimated from the view of the worker, and the speed, the target portion, and others are adjusted. Furthermore, when an operating doctor is performing an operation while being supervised by a doctor in a remote area, the supervising doctor can more appropriately advise the operating doctor by checking the view of the operating doctor. The display attributes are not limited to 1101 to 1107 in FIG. 14, and a mode desired by the user 120 can be added and deleted. Furthermore, aside from the display attributes described above, a method using the other display attributes for supporting an operation may be used.

Each of FIGS. 15A and 15B illustrates an example of a display attribute to be stored in the superimposed information storage unit 110. The display attribute is generated by the superimposed information constructing unit 305, and is recorded in the superimposed information storage unit 110. The display attribute includes at least a display attribute type 1201, position information 1202, a target superimposed information ID 1203, a size ratio 1204, and a transparent ratio 1205. The display attribute type 1201 will be described with reference to FIG. 14. One of the codes each representing a type of a display attribute in FIG. 14 is set to the display attribute type 1201 that is a value indicating how to display. The position information 1202 indicates values representing a screen position at which the screen is to be processed. For example, FIGS. 15A and 15B indicate two variations. The items 1201 to 1205 in FIG. 15A represent display attributes for an enlarged display, whereas the items 1206 to 1210 in FIG. 15B represent display attributes for a transparent display. The items will be described one by one. A code representing the enlarged display 1101 in FIG. 14 is assigned to the display attribute type 1201. Here, central coordinates in a portion corresponding to a screen to be enlarged are assigned to the position information 1202. The target superimposed information ID 1203 indicates the data ID 501 of the superimposed information when the superimposed information for which the screen is to be processed exists. Here, any value can be separately allocated to codes when the target superimposed information that matches the display attribute type 1201 is not identified or when the display attribute type 1201 is applicable to all the superimposed information to be stored in the superimposed information storage unit 110. Since it is assumed herein that the entire screen is enlarged and displayed with respect to the point indicated by the position information 1202, 0 is assigned to the target superimposed information ID 1203 that is not to be identified. A ratio for enlarged display is set to the size ratio 1204. The transparent ratio 1205 represents a value of a transparent degree in a display. The example herein is only for an enlarged display, and thus, the same magnification is set to the transparent ratio 1205. Next, the display attribute according to the items 1206 to 1210 in FIG. 15B when the superimposed information is transparently displayed will be described. A code representing the transparent display 1104 in FIG. 14 is assigned to the display attribute type 1206. Since the superimposed information is determined in this example, the position information 1207 is not used. Here, the position information 1207 may be set and used as necessary. For example, when an item to be transparently displayed is not the superimposed information but a range over the view, vertex coordinates at the four corners of a rectangle enclosing the range are stored. An ID of the superimposed information to be transparently displayed is stored as the target superimposed information ID 1208. The size ratio 1209 represents a value of an aspect ratio in a display, as the size ratio 1204. The example herein is only for the transparent operation, and thus, the same magnification is set to the size ratio 1209. Finally, the transparent ratio 1210 represents a value of a transparent degree in a display, and a semi-transparent degree of 0.7 is set to the transparent ratio 1210. Furthermore, when each of the display attribute types 1201 and 1206 is the simultaneous two-viewpoint display 1107, the data ID 501 of the superimposed information representing the viewpoint of one of the other nodes 130 is specified as the target superimposed information ID. Furthermore, the size ratio 1204 or 1209 is used also for the reduced display 1102.

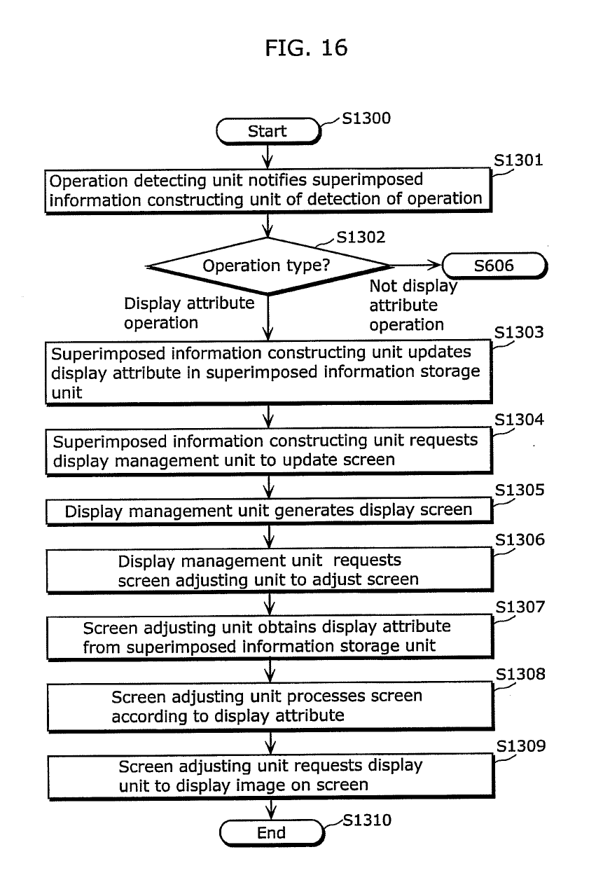

FIG. 16 is a flowchart indicating processes for reflecting the set display attribute on a display screen by the medical support apparatus 300 in FIG. 13.

Once the processes for detecting the user operation start, the operation detecting unit 304 notifies the superimposed information constructing unit 305 of detection of the operation (S1301). The processes for detecting the user operation is performed in the same procedure as the processes for detecting an operation (S601 to S604) in FIG. 6A.

The superimposed information constructing unit 305 determines whether or not the operation type 401 in FIG. 4 indicates an operation for the display attribute, with reference to the operation detecting information (S1302). For example, when the operation type 401 in the operation detecting information indicates an operation request instructing to display the processed information reserved as the display attribute type 1201, the superimposed information constructing unit 305 handles the operation type 401 in the operation detecting information as the operation for the display attribute. The types of display attributes include the view transition display 1106 in FIG. 14. When the operation type 401 does not indicate an operation for the display attribute, the processes according to the specified operation type 401 are continued. For example, when the operation type 401 indicates an operation of generating the superimposed information in FIG. 6A according to Embodiment 1, the processes after S606 are performed. When the operation type 401 indicates an operation for the display attribute, the superimposed information constructing unit 305 records the display attribute in the superimposed information storage unit 110 (S1303). The superimposed information constructing unit 305 notifies the view management unit 108 of the display attribute. For example, when the display attribute type 1201 is the view transition display 1106, setting the virtual viewpoint display in the same process as S809 in FIG. 9 according to Embodiment 2 enables using the viewpoint image at the switched destination in the following display processes. Furthermore, the information recorded as the display attribute includes one of the values 1 to 5 in FIG. 14. For example, when the display attribute type 1201 is the transparent display 1104, the superimposed information constructing unit 305 needs to determine the superimposed information indicated by the operation detecting position 402, with reference to the operation detecting position 402 included in the operation detecting information notified from the operation detecting unit 304. Since the position information indicated by the operation detecting position 402 are coordinate values in the intrinsic coordinate system at the node, the superimposed information constructing unit 305 transforms the values into the coordinate values in the common coordinate system, according to the same processes from S606 to S609. Next, the superimposed information constructing unit 305 searches the superimposed information storage unit 110 for the superimposed information at the point indicated by the calculated coordinate values in the common coordinate system, and identifies the superimposed information to be transparently displayed. The superimposed information constructing unit 305 records the data ID 501 of the identified superimposed information together with the transmission rate and the display attribute type 1201 that is the input transparent display 1104, as the display attributes in the superimposed information storage unit 110. The display attributes are applicable to the display attribute type 1201 of another display attribute, and similarly, the position information 1202 and the target superimposed information ID 1203 may be determined and set.

The superimposed information constructing unit 105 requests the display management unit 312 to update a screen (S1304).

The display management unit 312 generates the display screen (S1305). Here, the display screen is generated by performing the same processes as S616 to S621 in FIG. 6B according to Embodiment 1.

After generating the screen, the display management unit 312 requests the screen adjusting unit 116 to adjust the screen (S1306). The display management unit 312 makes the requests to process the screen according to the display attribute recorded in the superimposed information storage unit 110.

Upon receipt of the request from the display management unit 312, the screen adjusting unit 116 obtains the display attribute from the superimposed information storage unit 110 (S1307).

The screen adjusting unit 116 processes the display screen according to a value set to the obtained display attribute (S1308). For example, when the obtained display attribute is the enlarged display 1101, the display attribute type 1201, the position information 1202, and the size ratio 1204 are set to the display attributes. When the screen adjusting unit 116 determines that the obtained display attribute is the enlarged display 1101 from the display attribute type 1201, it reconstructs the display screen in an enlargement factor indicated by the size ratio 1204 with respect to the point indicated by the position information 1202. The screen adjusting unit 116 processes the screen using one or more of the display attribute type 1201, the position information 1202, the target superimposed information ID 1203, the size ratio 1204, and the transparent ratio 1205, for the other values of the display attribute type 1201. Furthermore, methods of processing the screen are not limited to the fixed methods. As long as the requirements represented by each of the display attribute types 1201 are satisfied, any methods can be used.

Next, the screen adjusting unit 116 requests the display unit 113 to display the screen. The display unit 113 that receives the request performs the same process as the process S624, and displays the screen (S1309). Then, the processes for reflecting the set display attribute on the display screen end.

As described above, the medical support apparatuses and the subsets worn by a plurality of users generate and transmit, in a coordinated manner, images viewed from respective viewpoints so that the views and operations from the respective viewpoints can be shared at the medial setting. Thus, it becomes possible to accurately support the medical work in a remote area. Furthermore, it becomes possible to control the display in more details, such as enlarged display of any point in a view and setting information other than superimposed information of a specific type to a non-display mode.

### INDUSTRIAL APPLICABILITY

The medical support apparatus according to the present invention shares data with the user in a remote area, and uses the bi-directional voice communication and the image communication including gestures. The medical support apparatus is useful not only for remote diagnosis and telemedicine, such as an operation.

### REFERENCE SIGNS LIST

100, 200, 300 Medical support apparatus
101 Image capturing unit
102 Attitude observing unit
103 Position observing unit
104, 304 Operation detecting unit
105, 305 Superimposed information constructing unit
106 Superimposed position determining unit
107 Superimposed image generating unit
108 View management unit
109 Coordinate transforming unit
110 Superimposed information storage unit
111 Communication unit
112, 312 Display management unit
113 Display unit
114 Virtual viewpoint generating unit
115 Image synthesis unit
116 Screen adjusting unit
120 User
130 Other nodes
201, 202 User
211, 212 Medical support apparatus worn by the user
213, 214, 215 Medical support apparatus not worn by the user

1. A medical support apparatus for sharing, among users, a view or an operation of at least one of the users, said medical support apparatus comprising:
an image capturing unit configured to capture an image according to the view of the user to obtain an image capturing signal;
an attitude observing unit configured to obtain information on an attitude of said image capturing unit;
a position observing unit configured to obtain information on an image capturing position of said image capturing unit;
an operation detecting unit configured to detect, from the image capturing signal obtained by said image capturing unit, the operation of the user and an operation position at which the user performs the operation, the user wearing said medical support apparatus;
a view management unit configured to manage the image capturing signal, the information on the attitude, and the information on the image capturing position in association with one another;
a superimposed information constructing unit configured to determine (i) superimposed details based on the operation detected by said operation detecting unit and (ii) information on the operation position based on the image capturing signal, the information on the attitude, and the information on the image capturing position, and generate superimposed information including the superimposed details and the information on the operation position;
a display management unit configured to generate a viewpoint image from the image capturing signal, generate an image by superimposing the superimposed details at the operation position on the viewpoint image, and display the image; and
a communication unit configured to transmit the superimposed information to at least one other medical support apparatus.

2. The medical support apparatus according to claim 1, wherein said position observing unit is configured to obtain the information on the image capturing position, using an intrinsic coordinate system of said image capturing unit, and said operation detecting unit is configured to obtain the information on the operation position, using the intrinsic coordinate system of said image capturing unit.

3. The medical support apparatus according to claim 2, further comprising
a coordinate transforming unit configured to transform the information indicated by the intrinsic coordinate system into information indicated by a common coordinate system common to said at least one other medical support apparatus,
wherein said superimposed information constructing unit includes:
a superimposed position determining unit configured to determine a position indicated by the information on the operation position using the common coordinate system, as a position at which the superimposed details are displayed; and
a superimposed image generating unit configured to generate the superimposed details as visual information according to a type of the operation.

4. The medical support apparatus according to claim 1,
wherein when said superimposed information constructing unit generates new superimposed information or updates the superimposed information, said communication unit is configured to transmit, to said at least one other medical support apparatus, a notification on the generating of the new superimposed information or the updating of the superimposed information, in addition to the superimposed information.

5. The medical support apparatus according to claim 1,
wherein said communication unit is configured to receive the superimposed information from said at least one other medical support apparatus, and
said display management unit is configured to generate an image by superimposing the superimposed details at the operation position on the viewpoint image based on the received superimposed information, and display the image.

6. The medical support apparatus according to claim 5,
wherein said communication unit is configured to receive, from said at least one other medical support apparatus, a notification on generating of new superimposed information or updating of the superimposed information in addition to the superimposed information, and
said display management unit is configured to generate an image by superimposing the superimposed details in response to the notification on the generating of the new superimposed information or the updating of the superimposed information, and display the image.

7. The medical support apparatus according to claim 1,
wherein said communication unit is configured to transmit the image capturing signal to said at least one other medical support apparatus.

8. The medical support apparatus according to claim 1,
wherein said communication unit is configured to receive an image capturing signal obtained by capturing an image by said at least one other medical support apparatus, and
said medical support apparatus further comprises:
a virtual viewpoint generating unit configured to generate virtual viewpoint information, based on an arbitrary position and information indicating respective positions of said two or more other medical support apparatuses near the arbitrary position; and
an image synthesis unit configured to generate an image using the arbitrary position as a virtual viewpoint, based on the virtual viewpoint information and respective image capturing signals received from said two or more other medical support apparatuses near the arbitrary position.

9. The medical support apparatus according to claim 1,
wherein the superimposed information is managed in association with display attribute information indicating a display mode of the superimposed details included in the superimposed information, and
said medical support apparatus further comprises a screen adjusting unit configured to process the image generated by said display management unit by superimposing the superimposed details, according to the display attribute information.

10. The medical support apparatus according to claim 1,
wherein said operation detecting unit is configured to detect the operation from the image capturing signal obtained by said image capturing unit, based on movement of a predetermined body part of the user who wears said medical support apparatus.

11. The medical support apparatus according to claim 1, further comprising
a superimposed information storage unit configured to store the superimposed information.

12. The medical support apparatus according to claim 1,
wherein said display management unit is configured to generate a left-eye image and a right-eye image for an observer.

13. A medical support system comprising a first medical support apparatus and a second medical support apparatus, for sharing, among users, a view or an operation of at least one of the users, each of said first medical support apparatus and said second medical support apparatus including:
an image capturing unit configured to capture an image according to the view of the user to obtain an image capturing signal;
an attitude observing unit configured to obtain information on an attitude of said image capturing unit;
a position observing unit configured to obtain information on an image capturing position of said image capturing unit;
an operation detecting unit configured to detect, from the image capturing signal obtained by said image capturing unit, the operation of the user and an operation position at which the user performs the operation, the user wearing said medical support apparatus;
a view management unit configured to manage the image capturing signal, the information on the attitude, and the information on the image capturing position in association with one another;
a superimposed information constructing unit configured to determine (i) superimposed details based on the operation detected by said operation detecting unit and (ii) information on the operation position based on the image capturing signal, the information on the attitude, and the information on the image capturing position, and generate superimposed information including the superimposed details and the information on the operation position;
a display management unit configured to generate a viewpoint image from the image capturing signal, generate an image by superimposing the superimposed details at the operation position on the viewpoint image, and display the image; and
a communication unit configured to communicate with at least one other medical support apparatus,
wherein said communication unit of said first medical support apparatus is configured to transmit the superimposed information to said second medical support apparatus,
said communication unit of said second medical support apparatus is configured to receive the superimposed information from said first medical support apparatus, and
said display management unit of said second medical support apparatus is configured to generate an image by superimposing the superimposed details at the operation position on the viewpoint image, based on the received superimposed information.

14. A medical support method for sharing, among users, a view or an operation of at least one of the users, said method being performed by a medical support apparatus including an image capturing unit that captures an image according to the view of the user to obtain an image capturing signal, and comprising:
obtaining information on an attitude of the image capturing unit;
obtaining information on an image capturing position of the image capturing unit;
detecting, from the image capturing signal obtained by the image capturing unit, the operation of the user and an operation position at which the user performs the operation, the user wearing the medical support apparatus;
managing the image capturing signal, the information on the attitude, and the information on the image capturing position in association with one another;
determining (i) superimposed details based on the operation detected by the operation detecting unit and (ii) information on the operation position based on the image capturing signal, the information on the attitude, and the information on the image capturing position, and generating superimposed information including the superimposed details and the information on the operation position;
generating a viewpoint image from the image capturing signal, generating an image by superimposing the superimposed details at the operation position on the viewpoint image, and displaying the image; and
transmitting the superimposed information to at least one other medical support apparatus.
